(19) United States
(12) Patent Application Publication
(10) Pub. No.: US 2022/0403725 A1
(43) Pub. Date: Dec. 22, 2022

(54) HIGH PRESSURE JUMPER MANIFOLD WITH FLEXIBLE CONNECTOR

(71) Applicant: BlueCore Completions, LLC, Midland, TX (US)

(72) Inventors: Travis Harrel, Midland, TX (US); Christian Leuchtenberg, Singapore (SG); Glen H. Cuiper, Haddon Township, NJ (US); Cham Hall, Westbrook, TX (US)

(21) Appl. No.: 17/843,391

(22) Filed: Jun. 17, 2022

Related U.S. Application Data
(60) Provisional application No. 63/211,983, filed on Jun. 17, 2021.

(51) Int. Cl. E21B 43/26; F16L 41/03

(52) U.S. Cl. CPC E21B 43/2607; F16L 41/03

(57) ABSTRACT

A jumper manifold with a flexible jumper for use in a fracing system including a first outlet interface for coupling to a first outlet line, a second outlet interface for coupling to a second outlet line, and an inlet interface for coupling to an inlet line carrying a slurry under pressure. A flexible jumper, in a first configuration, couples the inlet interface with the first outlet interface for transporting slurry from the inlet line to the first outlet line while isolating the second outlet line. The flexible jumper, in a second configuration, couples the inlet interface with the second outlet interface for transporting slurry from the inlet line to the second outlet line while isolating the first outlet line. The flexible jumper end connector has appendages for simplifying the accurate installation of plugs in any open ports on the outlets not in use.

### CROSS-REFERENCE TO RELATED APPLICATIONS

This Application claims the benefit of U.S. Provisional Application No. 63/211,983, filed Jun. 17, 2021, entitled HIGH PRESSURE JUMPER MANIFOLD WITH FLEXIBLE CONNECTOR, which is incorporated by reference herein in its entirety. The present application is related to U.S. Provisional Application No. 62/773,496 for HIGH PRESSURE JUMPER MANIFOLD, filed Nov. 30, 2018; U.S. Provisional Application No. 62/812,831 for HIGH PRESSURE AND HIGH FREQUENCY CONNECTOR, filed Mar. 1, 2019; U.S. Provisional Application No. 62/837,689, for HIGH PRESSURE AND HIGH FREQUENCY CONNECTOR ACTUATOR, filed Apr. 23, 2019, U.S. application Ser. No. 16/696,487, entitled HIGH PRESSURE JUMPER MANIFOLD, filed Nov. 26, 2019, which issued as U.S. Pat. No. 11,180,979 on Nov. 23, 2021, U.S. application Ser. No. 16/696,563, entitled HIGH PRESSURE AND HIGH FREQUENCY CONNECTOR AND ACTUATOR SYSTEM THEREFORE, filed Nov. 26, 2019, and U.S. application Ser. No. 17/531,629, entitled HIGH PRESSURE JUMPER MANIFOLD, filed Nov. 19, 2021, all of which are incorporated herein by reference in their entirety for all purposes.

### TECHNICAL FIELD

The present invention relates in general to fluid stimulation equipment for oil and gas wells and in particular to a fluid direction manifold subjected to severe operating conditions, such as the high pressures, high flow rates, and abrasive fluids commonly found in hydraulic fracturing operations and other oil and gas stimulation applications.

### BACKGROUND

In one of the most severe service applications known today, hydraulic fracturing (“fracing”), very high-pressure slurry is pumped at very high rates. In particular, fracing slurry is forced down a wellbore with enough pressure to fracture the hydrocarbon bearing rock formations and force particulates into the resulting cracks. When the pressure is released, the particles (“proppant”), which may be sand or other high compressive strength additives such as ceramic particles and bauxite, remain in the factures (cracks) and keep the fractures open. This “mechanism” then allows pathways for hydrocarbon to flow from the rock that was previously solid.

As the fracing industry becomes more efficient, multiple fracing stages are being pumped from a single “fracing factory”, consisting of many fracing pump trucks and accessory equipment to multiple wells, as first disclosed in U.S. Pat. No. 7,841,394, assigned to Halliburton. In order to make this process efficient, the concept of a distribution manifold was introduced as disclosed in US application 2010/0300672, assigned to FMC, which describes in detail the method of using such a manifold. This technique has become common practice, with this type of manifold commonly known as a zipper manifold in the hydraulic fracing industry.

When zipper manifolds started being used for fracing fluid distribution around 2009-2010, most wells were vertical, and the number of stages being pumped per well was around 10 to 20. (A stage is the process of pumping a mixture of proppant [sand], water and some chemicals down a wellbore under high pressure, usually in excess of 9000 psi, for fracturing a specific interval of the wellbore.) Since then, the industry has been getting more and more aggressive and most wells being fraced today are doing so in long horizontal wellbore sections having 50 to 100 stages.

A modern fracing operation typically runs 24 hours per day for several days. In the Permian basin of Texas, 70 fracing stages per well are now common. Each stage can last 1 to 2 hours and results in a small portion of the total wellbore being fractured. Then the pumps are stopped, and wireline is run. These wireline operations do a variety of things depending on the completion system being used. For example, a wireline can be used to set a plug, perforate a new zone, or open or close a sliding sleeve. This prepares a new section (interval) of the wellbore for fracing.

Then a new stage is pumped, fracturing the newly exposed wellbore. This process continues until all the sections of the wellbore have been fraced. It is common to achieve 8 to 15 fracing stages in a day, rotating the activity continuously between typically 3 wells. With 70 stages per well, this means that the zipper manifold is operating continuously for 14 to 28 days (excluding rig-up and rig-down time).

The frac flow is routed from the main incoming factory line (missile) to the distribution (zipper) manifold that is tied into multiple wells. This allows simultaneous operations, and for a 3 well pad with a 3-way zipper manifold it means that one well is having a frac stage being pumped, one is idle and one is having wireline operations. The number of fracing stages is increasing with up to 100 stages and more per well being possible in the foreseeable future.

This means that the valves on the zipper manifold are being opened and closed over 100 times on a three well pad job resulting in many problems. One problem is the wear of valves and subsequent downtime as the conditions for valves are typically very harsh at the zipper manifold location. The particle size distribution in these fracing fluids is distributed so that the larger particles can prop open larger cracks and finer particles can prop open the very tips of the cracks, which are microscopic in nature. The particle sizes can vary from 0.004 inches to 0.01 inches (No. 140 Mesh to No. 8 Mesh). The pumping pressure can be up to 15,000 psi and the slurry velocity through a valve bore of 5.125 inches, as is typical of a 5⅛-inch 15000 psi valve, is well above erosional velocity of about 50 to 70 feet per second. Moreover, the fracing is typically preceded and followed by an acid wash of 15% hydrochloric acid, which accelerates corrosion.

As one skilled in the art of mechanical engineering can ascertain, the fracing “mechanism” will inject proppant particles into any crack, orifice or possible leak path in the valve assembly. The injected particles remain in the valve assembly when the pressure is released. Small particles as large as 0.004 inches are within machining tolerances of steel parts and therefore will find their way into metal sealing surfaces. With the high velocity of abrasive fracing fluid, any weakness or point of turbulence can very quickly lead to a washout of a seal area or any interface. With ever increasing numbers of stages, the valve life limit can be reached during an operation resulting in repair/maintenance downtime. This is a safety problem as the repair person is exposed to an increased safety risk as all the equipment is interconnected.

With the zipper manifold always having one high pressure fracing operation concurrent with a residual pressure wireline operation, and possibly other preparation work on the idle well, there is a lot of room for errors. Even with procedures and strict protocols, accidents are common. A typical example occurs when there has been repair/maintenance work on a frac pump, after which the pump is started for testing. If this series of events was not properly regulated, high pressure can be applied accidentally via the zipper manifold to an undesired location.

The pressure pumping industry has become more automated with the use of hydraulic valves, which allow for automated operations from a safe remote location. As a result of this automation, human error has become more prevalent as it is extremely easy to simply “flip a switch” to open and close pressure barriers (i.e., valves). These pressure barriers are crucial for safety, since wells and pump trucks are potentially fatal pressure sources, and the operation of an incorrect pressure barrier may result in a fatal incident.

In a typical operation occurring for a three well pad scenario, Well #1 is idle and the zipper valves are closed, which isolates pump pressure to the wellbore. Well #2 is pumping and the zipper valves are open, such that pressure from the pumps is applied to the wellbore. Well #3 is undergoing wireline operations and the zipper valves are closed, isolating the pump pressure from the wellbore and the wellbore pressure back to the pumps.

Once Well #2 finishes pumping and the zipper manifold valves are shut, Well #2 becomes idle. However, Well #2 is still under pressure from the last frac stage, such that if the zipper manifold operator is instructed to open Well #1 to begin pumping, but instead accidently opens Well #2, the pumps are exposed to wellbore pressure. In this scenario, it is highly probable that the high-pressure piping connected to the pumps is disconnected, as the pumps also require frequent maintenance during operations. The workers repairing the pumps are then subject to injury.

When using a zipper manifold, the in-line flowline valves (“ground valves”) between the zipper manifold and the pumps are typically left open because the zipper manifold valves are used to provide the primary pressure barrier, with two valves being used in series for double isolation. These valves are operated as isolation or flow pairs, being opened and closed one after another. The valves closest to the pumps on the manifold are exposed to every frac stage of all the wells being fraced. So, on a three well pad, these valves are subjected to up to 200 to 300 stages of frac slurry. Because of this, the zipper manifold valves are the most likely to malfunction, which causes the non-productive time and safety hazards.

It is of course possible to work without a zipper manifold and instead use a movable flowline, as disclosed in U.S. Pat. No. 8,590,556 assigned to Halliburton. Here the valves on the truck are used as isolation valves and the fracing line is disconnected and swung over to the next well being fraced. The well that is being wirelined and the well that is idle are both isolated as they are disconnected completely from the main fracing line that is connected to the pumps. This method eliminates the possibility of exposing the pumps to wellbore pressure of the wells not being fraced. However, this method requires workers to be in the “red zone” (i.e., the “widow maker area”) a distance of 75-100′ from an area around the flowline between the wellhead and pumps. The Halliburton design requires an operator to control the movable flowline from the truck within this “red zone”.

There is a need to further reduce the activity of personnel in the dangerous area between the pump trucks and the wells. The introduction of zipper manifolds with hydraulic valve actuators has not fully solved this issue, as personnel are required more and more frequently to repair valves on the zipper manifold with ever increasing numbers of fracing stages. With these stages creating more demand on the pumps, these valves are also being repaired with ever increasing frequency on jobs. Both types of repairs require opening of components that are directly connected to pressure sources, either the well or the pumps. The easy actuation of valves via hydraulics has increased the number of safety incidents and this will continue to increase as maintenance activity increases with more stages.

The fracing industry in its desire to ever increase efficiency is now looking at 6 well pads, as horizontal placement of wellbores allows for design efficiency. This will mean one fracing factory of multiple pumps being interfaced with 6 wells using two three-way zipper manifolds or other efficient configurations with many more valves leading to further safety issues.

There is a need for a more reliable manifold solution that: eliminates down time due to valve repair; provides a safer method of operation and can be easily expanded to more well pads. Such a manifold solution termed “jumper manifold with a flexible connector” is presented.

Advantageously such a jumper manifold also requires a very reliable high-pressure connector that needs to be connected and disconnected many times during these types of continuous fracing operations without requiring maintenance. This is also disclosed.

### SUMMARY

To reduce the activity of personnel in the danger area, the dual isolation valves being used as pressure barriers are removed and replaced with a jumper and sealing plugs. The jumper is a piece of pipe that can be easily moved between the main incoming flowline from the fracing factory and the outgoing line to each well. The jumper is installed between the incoming high-pressure fracing line and the well being fraced. This means the other wells are physically completely disconnected from the high pressure incoming fracing line. Only the well being fraced is connected to the fracing factory. The removable sealing plugs are installed in the outgoing lines to the other wells. This makes it physically impossible to reroute pressure from a high-pressure source to a low-pressure source. Any idle wells or wireline operations are fully isolated from the pump pressure source. There are no valves; therefore, the new jumper manifold does not require the repair and maintenance issues of a zipper manifold with valves, which are the main cause of downtime.

The system is more reliable than valves as there are no moving valve parts to fail. The jumper and sealing plug connections are made under no pressure conditions and the design allows for multiple seal barriers that do not move when under pressure. The jumper and plugs are remotely operated to move between ports and latched with remotely controlled latches, requiring no personnel at the jumper manifold. Pressure interlocks are provided as part of the system to eliminate the possibility of opening a line under pressure. The design will allow the full number of stages to be pumped for each well without wear of the pressure connection and therefore will be safer as it will not require the maintenance of a zipper manifold.

The jumper and the plug connection to the manifold disclosed is an advantageous solution that can endure the hundreds of connection and disconnection sequences required, and seal high-pressure reliably without requiring maintenance, while in use for many days during a multi-well fracing operation. Such a connection as advantageously designed fit for purpose is more reliable than a valve and this is the goal of this invention, which is to have a more reliable manifold, replacing conventional zipper manifolds, that does not require any valves.

For this new embodiment of a jumper manifold, the advantages for utilizing a flexible jumper such as a high-pressure hose is shown. Recent advances have enabled the use of flexible hoses that have been designed for purpose to be used for connecting fracing flow systems. This has many advantages over the traditional multiple small hammer union lines and the very recent use of big bore flanged piping. These flexible fracturing hoses are now available in many sizes and pressure rating suited for fracing operations. As will be shown in embodiments of the invention, using such a flexible hose as the “jumper” enables many advantageous features for the system such as: a) elimination of misalignment problems common with rigid pipes and jumpers; the inherent flexibility of a hose allows the small movements in three dimensions that eliminates alignment problems. b) the flexibility of the design also allows the use of a novel movement path and mechanism to enable better and faster connections. These features will be explained in detail to highlight this new advantageous design. Finally, the smooth curve of the hose without any sharp change in directions enables the long life of the flexible jumper compared to the sharp bend present in the rigid jumper design disclosed in prior art.

In another aspect, a jumper manifold for use in a fracing system comprises a first outlet interface for coupling to a first outlet line, a second outlet interface for coupling to a second outlet line, and an inlet interface for coupling to an inlet line carrying a slurry under pressure. A flexible jumper is operable to: in a first configuration, couple the inlet interface with the first outlet interface for transporting slurry from the inlet line to the first outlet line while isolating the second outlet line; and in a second configuration, couple the inlet interface with the second outlet interface for transporting slurry from the inlet line to the second outlet line while isolating the first outlet line.

In yet another aspect a skid-mounted jumper manifold for use in a fracing system comprises a first outlet interface mounted to a skid frame for coupling to a first outlet line, a second outlet interface mounted to the skid frame for coupling to a second outlet line, and an inlet interface mounted to the skid frame for coupling to an inlet line carrying a slurry under pressure. An actuator arm has an inner end pivotally mounted to an arm guide extending from the skid frame, the actuator arm operable to pivot horizontally about the arm guide such that an outer end of the actuator arm can swing between a first location positioned above the first outlet interface and a second location positioned above the second outlet interface. A flexible jumper has a first end connectable to the inlet interface and a second end positioned by the outer end of the actuator arm and connectable to one of the first and second outlet interfaces. The flexible jumper is operable in a first configuration with the outer end of the actuator arm positioning the second end of the flexible jumper above the first outlet interface, to couple the inlet interface with the first outlet interface for transporting slurry from the inlet line to the first outlet line. The flexible jumper is operable in a second configuration with the outer end of the actuator arm positioning the second end of the flexible jumper above the second outlet interface, to couple the inlet interface with the second outlet interface for transporting slurry from the inlet line to the second outlet line.

In one embodiment, the skid-mounted jumper manifold further comprises a hydraulic cylinder connected to the arm guide for selectively raising and lowering the actuator arm relative to the skid frame. Raising and lowering the actuator arm raises and lowers the second end of the flexible jumper relative to the skid frame to facilitate coupling and uncoupling of the second end of the flexible jumper with one of the first and second outlet interfaces.

In another embodiment, the skid-mounted jumper manifold further comprises a swing arm having an inner end pivotally mounted to the outer end of the actuator arm. The swing arm is operable to pivot horizontally about the outer end of the actuator arm above the second end of the flexible jumper. The swing arm is configured to have an outer end spaced apart from the inner end such that when the actuator arm positions the second end of the flexible jumper aligned above one of the first and second outlet interfaces, the outer end of the swing arm can pivot into position aligned above another of the first and second outlet interfaces.

In yet another embodiment, the skid-mounted jumper manifold further comprises a plug adapted to be received into one of the first and second outlet interfaces for isolating the respective outlet interface when received therein. A plug catcher is attached to the outer end of the swing arm and adapted to selectively connect to the plug for moving the plug from one of the first and second outlet interfaces to another of the first and second outlet interfaces.

In a further embodiment, a method of switching between wells during fracing operations comprises coupling a first line between a first output port of a manifold and a first well, coupling a second line between a second output port of the manifold and a second well, and coupling, with a jumper, the first output port of the manifold with an input port of the manifold. The method further comprises coupling fracing fluid from the input port of the manifold to the first well through the jumper and the first line. The method further comprises recoupling the jumper between the second output port of the manifold and the input port of the manifold. The method further comprises coupling fracing fluid from the input port of the manifold to the second well through the jumper and the second line.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a block diagram of a typical prior art conventional fracing operation installation;

FIG. 2A is diagram of a typical conventional prior art zipper manifold system;

FIG. 2B is an enlarged view of the input connector assembly (cross) of FIG. 2A;

FIG. 2C is an enlarged view of the output connector assembly (cross) of FIG. 2A;

FIG. 3A is a schematic plan view of an exemplary embodiment of an installed jumper manifold system according to the present principles;

FIG. 3B is a side view of the jumper manifold system of FIG. 3A;

FIG. 3C depicts a detail of manipulation of the jumper system of FIG. 3A;

FIG. 4 is an alternate jumper manifold embodiment adapted to connect with up to six wells;

FIG. 5 is an isometric view of a particular embodiment of a jumper manifold according to the inventive principles;

FIG. 6A is an isometric view of the jumper shown in FIG. 5;

FIG. 6B is an isometric view of a selected one of the plugs shown in FIG. 5;

FIG. 6C is an isometric view of a selected one of the clamping mechanisms shown in FIG. 5;

FIG. 7 is an isometric view of the detail of a selected one of the connector assemblies of FIG. 5 with a quarter cut-out;

FIG. 8 is an isometric view of an embodiment of the new disclosure;

FIG. 9 is a plan view of the new embodiment shown in FIG. 8;

FIG. 10 is side view of the new embodiment shown in FIG. 8;

FIG. 11 is a section view of the new embodiment shown in FIG. 8;

FIG. 12 is a detailed part isometric view of the movement mechanism for the embodiment disclosed in FIG. 8;

FIG. 13 is a detailed part isometric view of the movement mechanism for the embodiment disclosed in FIG. 8, shown in a different position;

FIG. 14 is a detailed part isometric view of the movement mechanism for the embodiment disclosed in FIG. 8, shown in a different position;

FIG. 15 is a cross section of an alternative embodiment of the disclosed in FIG. 8.

### DETAILED DESCRIPTION

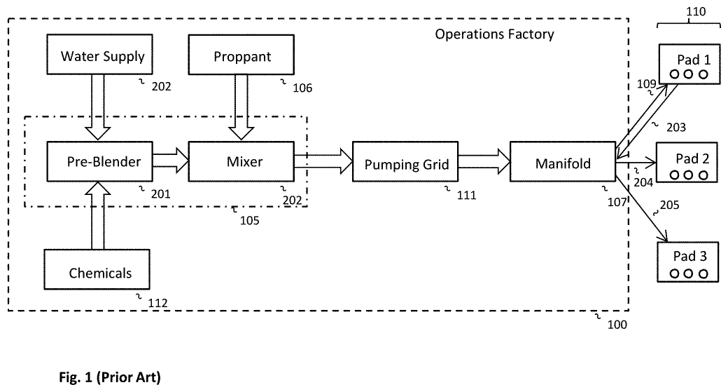

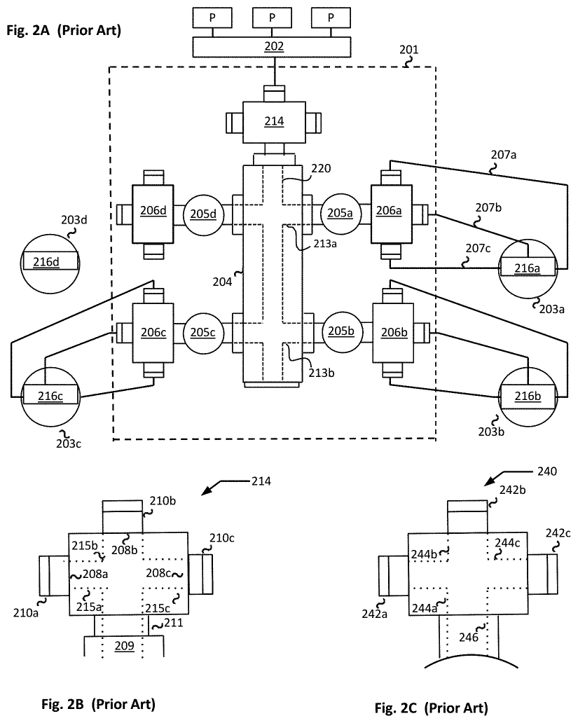

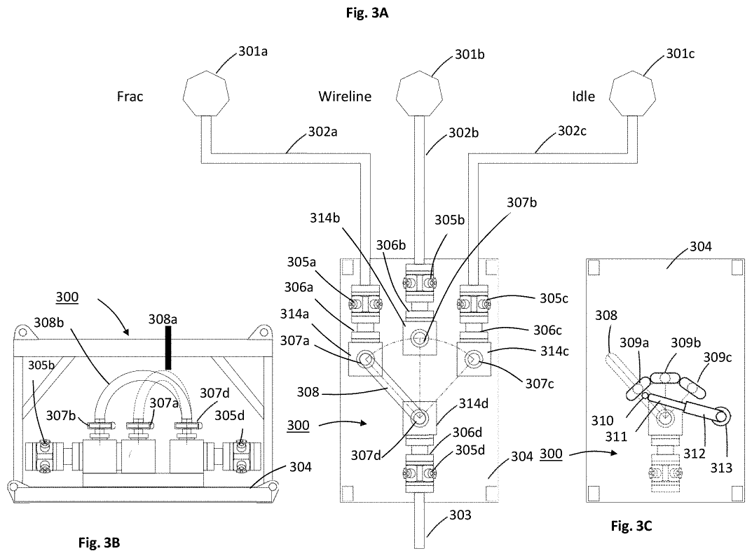

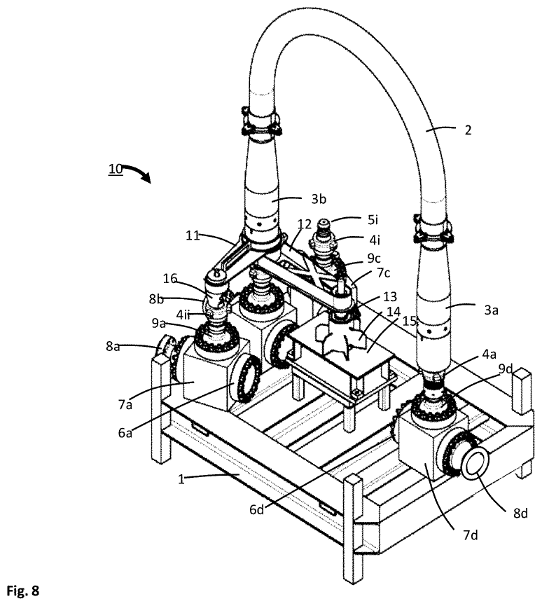

The principles of the present invention and their advantages are best understood by referring to the illustrated embodiment depicted in FIGS. 1-15 of the drawings, in which like numbers designate like parts. FIGS. 1-2 describe prior art from third parties, FIGS. 3-7 describe disclosures by the current inventors, and FIGS. 8-15 describe further new inventions and embodiments thereof.

FIG. 1 is a block diagram of a prior art hydraulic fracturing installation, as disclosed in U.S. Pat. No. 7,841,394 assigned to Halliburton. FIG. 1 shows the typical installation used for most fracing operations, which includes an operations factory 100 consisting of a blending unit 105 connected to a chemical storage system 112. The blending unit 105 includes a pre-blending unit 106 wherein water is fed from a water supply 108 and blended with various chemical additives and modifiers provided by the chemical storage system 112.

This mixture is fed into the blending unit's hydration device and the now near fully hydrated fluid stream is blended in the mixer 107 with proppant from the proppant storage system 109 to create the final fracturing fluid. This process can be accomplished continuously at downhole pump rates. The final fluid is directed to a pumping grid 111, which commonly consists of several pumping units that pressurize the frac fluid, which is subsequently directed to a central manifold 107. The central manifold 107 connects and directs the fluid via connections 109a-109c to multiple wells 110 simultaneously or sequentially. The manifold 107 is typically known in the industry as a zipper manifold. One advantage of the principles of the present invention is the replacement of this manifold.

FIG. 2A is a prior art design of a typical zipper manifold system having the common features used by almost all fracing companies today. FIG. 2A shows a zipper manifold 201 connected between a high-pressure frac vessel 202 and a number of representative wellheads 203a-203c. The high pressure frac vessel 202 is fed by a number of high-pressure pumping units P. In certain applications, however, the high pressure frac vessel 202 may be eliminated and the pumping units P connected directly to the zipper manifold 201. The zipper manifold 201 includes a block member 204, which is ideally a solid piece of metal through which a flow bore is machined. The flow bore includes an inlet branch 220 and a number of outlet branches 213. At least one inlet cross 214 is connected to the block 204 by suitable means, such as bolts (not shown).

Referring also to FIG. 2B, the inlet cross 214 comprises a body 211 and a number of inlet bores 215, each of which extends through the body between a corresponding inlet port 208 and a common outlet bore 209. The inlet cross 214 is connected to the body such that the outlet bore 209 is in fluid communication with the inlet branch 220 of manifold 201. The inlet cross 214 also includes a number of inlet connection adapters 210, each of which is connected to the body 211 over a corresponding inlet port 208 by, for example bolts. The inlet connection adapters 210 may comprise any suitable connector to which a corresponding connector may be secured, such as an adapter union.

The zipper manifold 201 also includes a number of valves 205a-205d, each of which is connected (e.g., bolted) to the block 204 over a corresponding end of an outlet branch 213. Thus, each valve 205 serves to control the flow of fluid from a corresponding outlet branch 213. Although the valves 205 may comprise any suitable flow control device, in FIGS. 2A and 2B they are manually operated gate valves. Today, modern zipper manifolds usually have dual isolation valves instead of the single isolation valves 205, which may also be plug valves. These dual isolation valves are usually equipped with hydraulic actuators that are remotely controlled. The zipper manifold 201 further includes a number of outlet crosses 206a-206d, each of which is connected to a corresponding valve 205. The outlet crosses are ideally of identical construction to the inlet cross 214 discussed above.

Referring also to FIG. 2C, each outlet cross 206 comprises a number of outlet connection adapters 242a-242c, similar to the inlet connection adapters 210, which are each connected to a corresponding outlet passage 244a-244c. The outlet passages 244 are each connected to a common inlet passage 246. The inlet passage 246 is in turn connected via the valve 205 to a corresponding outlet branch 213 in the block 204. Thus, each valve 205 serves to control the flow of fluid from the flow bore 220 to all of the outlet passages 244 in a corresponding outlet cross 206.

In use, the high pressure frac vessel 202 is connected to the inlet cross 214 and each outlet cross 206 is connected to a corresponding frac tree 216, which has been installed on a respective wellhead 203. In particular, a number of high-pressure lines 207a-207b connect the high pressure frac vessel 202 to corresponding inlet connection adapters 210 on the inlet cross 214. Also, each outlet connection adapter 242 on a particular outlet cross 206 is connected to a high-pressure line 207 which in turn is connected to a corresponding inlet connection on the frac tree 216. Thus, while the inlet cross 214 is connected to multiple pumps lines, each frac tree 216 is connected to a single outlet cross 206. However, since each outlet cross 206 comprises multiple outlet passages 244, a single frac tree 216 may be connected to several high-pressure lines 207. Moreover, since flow from the flow bore 220 into each outlet cross 206 is controlled by a corresponding valve 205, each of these high-pressure lines 207 can be controlled with a single valve, or as in the case with a modern zipper manifold, dual valves with hydraulic actuators that are remotely controlled.

The block member 204 and the valves 205 are preferably supported on a single skid and connected to the skid by suitable means, such as mounting brackets (not shown). This arrangement allows the zipper manifold 201 to be transported and positioned on site as a unified assembly. Different versions of this type of arrangement, which provide more outlets such as four or six are in common use.

As discussed above, one problem faced with these prior art manifolds, particularly in view of the ever increasing number of frac stages, is the reliability of the valves. The need for valve repairs leads to downtime, as well as increased risk to personnel who must work in the danger zone. Furthermore, remote operation can lead to operational disconnects in communication and incorrect routing of high-pressure slurry, which is a main cause of accidents on fracing operations. A system is therefore required that eliminates the use of valves and replaces them with an advantageous arrangement, which will be referred to as a jumper manifold to distinguish it from a conventional zipper manifold.

FIG. 3A is a schematic plan view of one embodiment, showing a jumper manifold 300 installed. FIG. 3B is a side view of the jumper manifold 300 and FIG. 3c shows a detail of the manipulation of the jumper 308.

The function of this jumper manifold 300 is generally the same as in the prior art discussed in FIGS. 2A to 2A. However, jumper manifold 300 has no valves and is suitable for use with single large bore lines, instead of many small lines, a concept known as monobore in the industry.

In the embodiment of FIG. 3A, three wells 301a, 301b and 301c are shown being supplied by three monobore lines 302a, 302b and 302c, respectively. Monobore lines 302a, 302b, and 302c are connected to distribution spools 305a to 305c, which are preferably that the same type as spool 206 in FIG. 2A. Advantageously, jumper manifold 300 may be rigged up in the conventional way, with several outgoing lines for the spools 305a to 305c. In the example shown in FIG. 3A, the unused bore outlets on the spools 305 are plugged with a blind flange (not shown).

Similarly, the inlet line 303 is shown as a monobore, which can be replaced by multiple lines coming into spool 305d. Spools 305 can have 3 to 6 inlets or outlets each and are connected to blocks 314a to 314d. In alternate embodiments, spools 305a to 305d may be connected though a single block containing parts 305, 306 and 314. The blocks 314a to 314d have mechanical connectors 307a to 307d connected on top that can be remotely actuated to open and close and effect a connection. Preferably, the entire jumper manifold 300 assembly is mounted on a single skid 304.

Assuming, for discussion purposes, that it is desired to frac well 301a. Then a jumper 308, which is a pipe or other conduit with two end connectors, is installed between blocks 314a and 314d. Specifically, the jumper 308 is mechanically latched with connectors 307a and 307d respectively to affect a pressure tight connection.

Connectors 307b and 307c preferably have solid plugs installed (not detailed) so that the lines 302b and 302c are isolated from possible pressure sources 301b and 301c respectively. As a result, there is a direct connection from inlet line 303 to well 301a, such that well 301a is completely isolated from wells 301b and 301c, with no valves in the configuration that can leak, fail or be inadvertently operated. The mechanical connectors (latches) 307a to 307d preferably include pressure interlocks preventing their unlatching under pressure.

If it is desired to fracture the next stage for well 301b, then line 302b will be isolated by two valves on the frac stack (not shown) on well 301b, and depressurized by a bleed line (not shown). Then the connector 307b can be opened and the plug (not shown) removed. Thereafter line 302a from well 301a can be similarly isolated and depressurized as previously done for line 302b.

The upstream inlet line 303 from the frac pumps can be isolated by the dual isolation valves present in the main frac line (not shown, off skid) and bled off. Now the jumper 308 can be unlatched between connectors 307a and 307d, lifted and pivoted to enable latching with connector 307b, where previously the plug has been removed. The jumper 308 is lowered and then latched with connectors 307b and 307d. A blind plug is installed in latch 307a. Now well 301b can be worked with fracturing pressure, leaving well 301a and well 301c completely isolated for other activities like wirelining.

In FIG. 3B, the prior position 308a of jumper 308 is shown in broken lines and the new position 308b after changeover is indicated in solid lines. In FIG. 3C, a simple method of mechanical manipulation is shown with jumper 308 capable of being lifted and lowered by pistons 309a, 309b and 309c. A pivot point 310 is attached to a piston 311 and engaged in a cylinder 312 that is mounted on a stand 313 attached to skid 304. Stand 313 can move up and down as the jumper is raised and lowered and, by means of actuation, such as air or hydraulic fluid, can pivot the jumper into the desired position. There is any number of ways of achieving the desired manipulation of one end of the jumper 308 between connectors 307a to 307c, while the other end stays in alignment with connector 307d.

As the connection between the jumper and the plugs to the blocks is a vertical one, alignment can be carefully controlled and multiple seals or metal seals may be used, as there are no tolerance requirements, such as those required for moving a valve member. Consequently, the sealing system will be much more reliable than a valve and removes failure points.

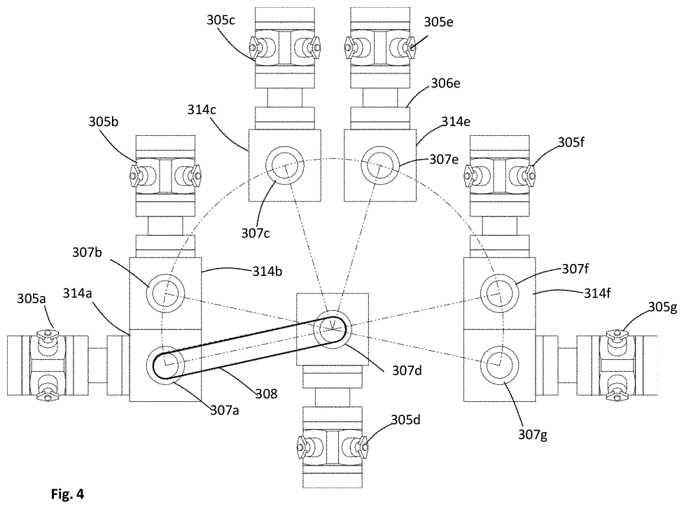

In FIG. 4, another embodiment is shown, which is designed to connect with up to six wells. An advantageous aspect of this particular embodiment is the circular nature of the arrangement, which enables numerous outlet legs to be assembled on a single manifold. In particular, outlet spools 305a, 305b, 305c, 305e, and 305f can be individually supplied by one inlet spool 305d connected to connector 307d. (Preferably, for all embodiments of the present principles, there is only one jumper, though a spare maybe carried.) It is very difficult or impossible to misconnect the jumper 308. Jumper 308 is shown installed between connector 307d on the inlet and connector 307a on the outlet. It can be moved by manipulation (not shown) to any of the outlet connectors 307b, 307c, 307e, 307f and 307g. Monobore lines may be used or multiple lines connected to spools 305.

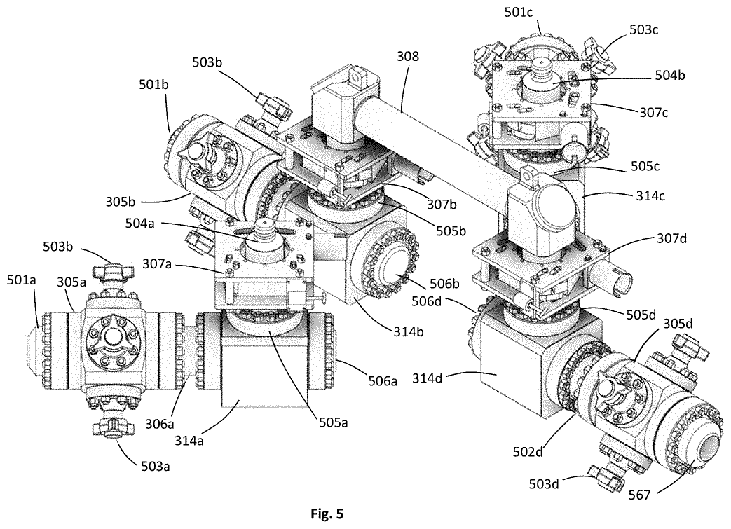

FIG. 5 is an isometric view of a embodiment of the jumper manifold. This example is configured for a monobore line with an inlet line flange 567 and outlet line flanges 501a-501c. The multiple inlet/outlet line options on spools 305a and 305d are capped with plugs 504a -504d. The blocks 314a-314d are designed as tee blocks with blind flanges 506a-506d on the unused side. This allows blocks 314a-314d to be rotated by 180 degrees if excessive erosion occurs on the flow outlet. The jumper 308 is shown installed between inlet connection mechanism 307b and outlet connection mechanism 307d.

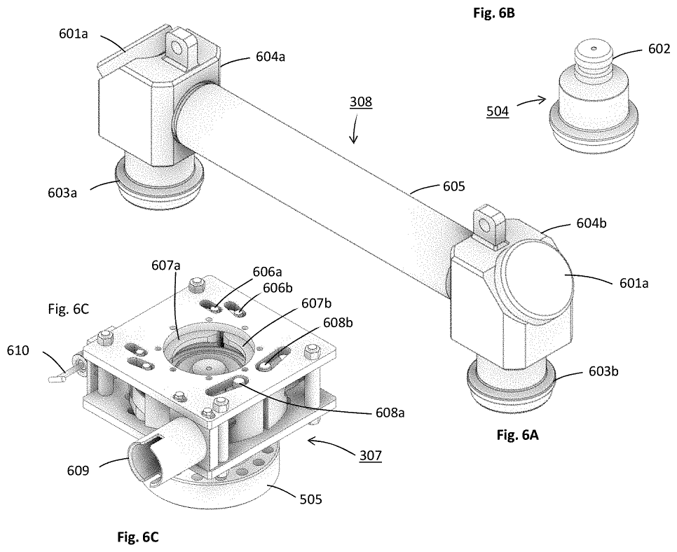

FIG. 6A is an isometric view of the jumper 308 from FIG. 5 and consists of a tube 605 that is welded or connected by other means to two identical blocks 604a-604b. These blocks 604a-604b have upper adapters 603a-603b attached with a profile suitable for the connector mechanism shown in FIG. 6C and a sealing system (not shown). The blocks 604a-604b have threaded caps 601a-601b set into the corner of the blocks, which are removable, replaceable pieces to accommodate the inevitable erosion by fracing fluid through the ninety degrees turn in the blocks 604a-604b.

FIG. 6B is an isometric view of a plug 504 having the same connector profile as adapters 603 with a sealing system (not shown). The plug 504 has a handling profile 602 that allows easy latching and unlatching for a mechanical handling system for installing or removal of the plugs.

FIG. 6C is an isometric view of a connection mechanism 307 that is commonly used for hub connectors. Each connection mechanism 307a-307d is mounted on a lower adapter 505a-505d that has a top face (not visible) that can mate with the sealing system (not shown) on adapters 603 located on the jumper 308 and plugs 504. It has three latching clamps (only latching clamps 607a-607c are visible) that can rigidly grip the upper adapters 603 and sealingly connect them to the corresponding lower adapter 505. The connection mechanism 307 has a rotating adapter 609 that rotates and then opens or closes the clamp mechanism as guided by pins 608a-608b. Additional guide pins 606a-606b guide the other latching clamps 607a-607b concentrically. A visual indicator 610 shows if the clamp is closed or open. The rotating adapter 609 can be driven by electrical, pneumatic or hydraulic means. This is just one example of a latching mechanism that could be used for the jumper manifold of FIG. 3A. Other latching systems are possible.

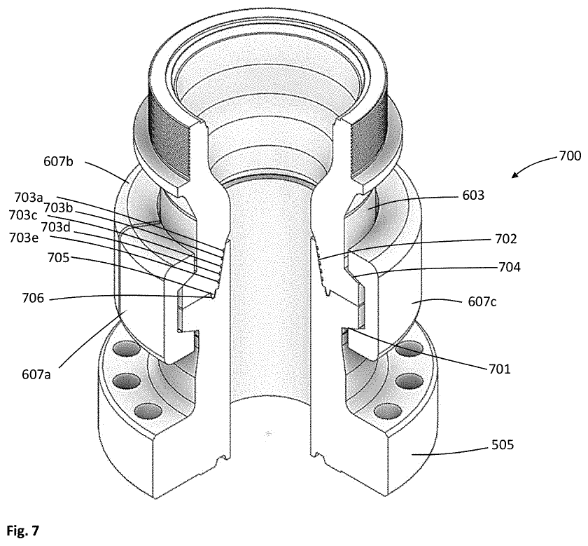

FIG. 7 is an isometric view of a connector assembly 700, consisting of an upper adapter 603 and a lower adapter 505, with a partial cut-out. This can be closed and opened by the rotating adapter 309 described in FIGS. 6C, which acts on the three latching clamp segments 607a-607b. The upper adapter 603 is shown with a threaded connection that connects to the blocks 604a-604b (FIG. 6A), but it could also be a weld. Adapter 603 could also be replaced by the blind plug 504 shown in FIG. 5. The three latching clamps 607a-607b have internal tapers that when driven inward, act against the corresponding tapers 704 and 701 of the connector to pull the upper adapter 603 and lower adapter 505a-505d together until sealing at the sealing interface 702. The particular requirements of this connector include providing the required performance of several hundred connect/disconnect cycles, without losing seal integrity when the connection is under high pressure, as well as enduring the particular peculiarities of fracing fluids. These requirements have been addressed by the following features which will be explained in detail: a) vertical movement for connection/disconnection; b) operable without grease as this is not desirable due to the frac particulates; c) multiple seals so that any one seal failure will not affect performance; d) seals on the movable and removable items, plugs and jumper(s), that can be easily replaced and serviced; e) designed to be able to handle spill of frac fluids with particulates without affecting sealing performance.

These design requirements preclude the use of metallic seals or other hard seals, which could be affected by frac particulates, such as sand. The possibility of sand entrapment also precludes the use of a pre-loaded connector. The choice of seals 703a-703e is for resilient seals which may have a back-up ring or scraper ring as part of the individual seal or seal assembly. A secondary guide, consisting of a circumferential protrusion 706 on the upper adapter 603, engages in a corresponding circumferential groove 705 on the lower adapter 505.

The following FIGS. 8 to 14 now disclose an advantageous design of the jumper manifold using a flexible hose as the jumper. In some embodiments, the flexible hose many be a standard “off the shelf” flexible hose and in other embodiments it may be a custom flexible hose. The other differential feature is the use of an actuating mechanism that is operating from a central pivot point on the jumper manifold skid. This enables more precise and ultimately efficient handling of the connection process and the plugs. The jumper manifold assembly 10 in FIG. 8 discloses a skid 1 on which an inlet T-block 7d has been mounted with an inlet 8d and a blind flange 6d on the opposite side. On the top outlet of the block is a X-over 9d made from a flange welded to a male hammer union 4a. The jumper instead of being a solid steel assembly consists of a hose 2 suited for fracing which has a swaged inlet end 3a to a female (threaded) hammer union. At the outlet end the hose is swaged 3b to a male hammer union 4b that connects to a T-Block 7b through a X-over 9b that has a female hammer union thread 18b at the top and flange that connects to the block 7b. The outlet is 8b which can be any appropriate connector as being used for the required rig-up. The other outlet blocks 7a and 7c are of the exact same design having outlets 8a and 8c respectively as well as X-overs 9a and 9c respectively.

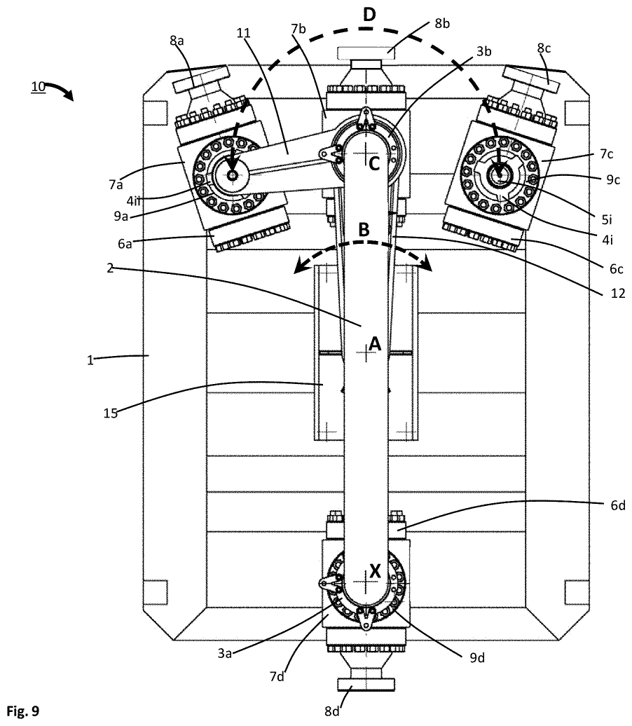

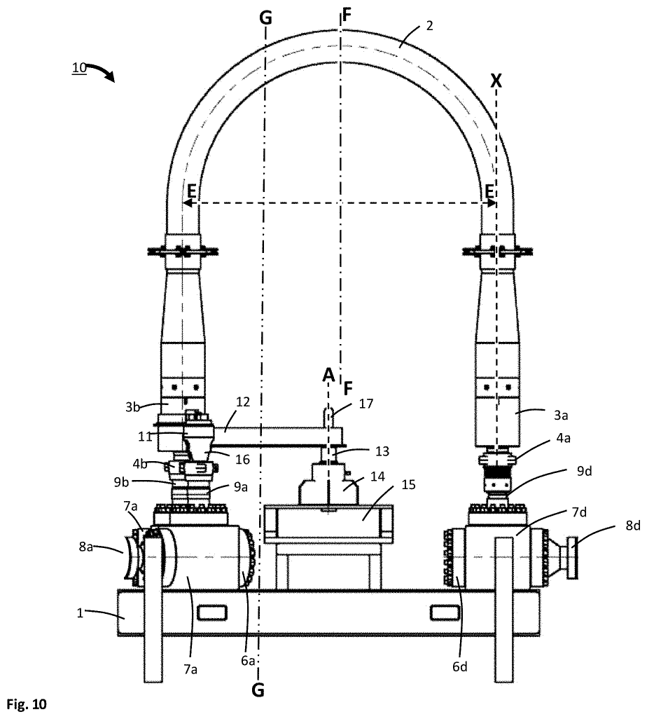

This FIG. 8 shows the flexible jumper connecting inlet 8d to outlet 8b. The other two outlets 8a and 8c are isolated by plugs 5i and 5ii held in place by male hammer unions 4i and 4ii respectively (see, e.g., FIGS. 9 to 11 for items not numbered on FIG. 8). In the center of skid 1 is a sub-skid 15 which secures a hydraulic cylinder support 14 to the main skid 1. The hydraulic cylinder support houses a hydraulic cylinder 13 with a guide rod 17 (see FIG. 10). An actuation arm 12 is attached to the cylinder 13 and the other end to the swaged end 3b of the hose. A swing arm 11 is sitting on top of the hose end of the actuation arm 12, and it has a plug catcher 16 attached to it. The mechanism of operation will be further explained herein.

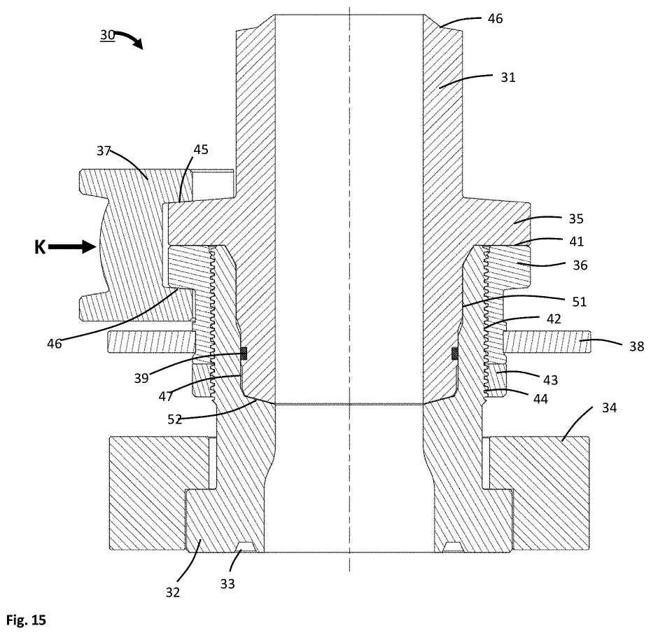

Referring now to FIG. 9 a plan view of the new flexible jumper skid design, we outline the differences compared to the alternate design of FIGS. 4, 5 and 6. Looking at the inlet side 8d of the jumper manifold assembly 10, we see a pivot point X marked on the central vertical axis through the bore of the X-over 9d. This, X, was the pivot point of the alternate design as can be seen in FIGS. 3a to 3c. This new flexible jumper design has a new pivot point A which is located close to the centre of the skid 1, but not necessarily aligned with the centre of the flexible hose 2. Pivot point A is the exact centre of cylinder 13, and actuation arm 12 swings through arc B as the end of the hose 2, male hammer union 4b locates to either X-over 9a or 9c. The swing arm 11 which is used to manipulate the plugs 5i and 5ii has a pivot point C which is the vertical central axis through X-over 9b. It can move on an exact arc D, which enable precise positioning of the plugs 5i and 5ii as required. The arc B from pivot point A also precisely restricts the movement of the hose end 4b so that it can align perfectly with the required connection point. This is a key advantageous feature that other designs have struggled with the exact alignment requirements for jumpers given the size and weight of the connectors involved. The embodiment(s) from FIGS. 8 to 14 use simple hammer union(s) for ease of explanation, but in other embodiments more robust, and possibly less flexible to alignment issues, connectors like the clamp connectors of FIG. 7 and/or the revised clamp connector of FIG. 15 could be used.

FIG. 10 which shows a side view of the flexible jumper manifold will illustrate further benefits of this new arrangement. When the actuator arm 12 pivots around axis A forcing the hose end 4b to move in arc B (FIG. 9), then the hose 2 pivots on axis X (with the hammer union connection slacked off). As the two centres of rotation are offset, the virtual central axis of the hose F-F describes a different arc and this will not be aligned with axis A, as shown by the offset between them in the drawing. The hose being flexible is able to change the distance E-E between the axis of the hose centres 4a and 4b. Also because of the flexibility of the hose loop, small variation in horizontal alignment of the connections 9a to 9c with the inlet 9d can be accommodated. These can be caused by manufacturing, rough handling or even when rigging up, with heavy inflexible solid pipe on the inlet 8d or outlets 8a to 8c causing flexion of the skid 1 due to torsion. The flexibility of the hose will overcome all of these difficulties and when the connections are tightened after a “jump” transmit these misalignments to the flexible part of the hose.

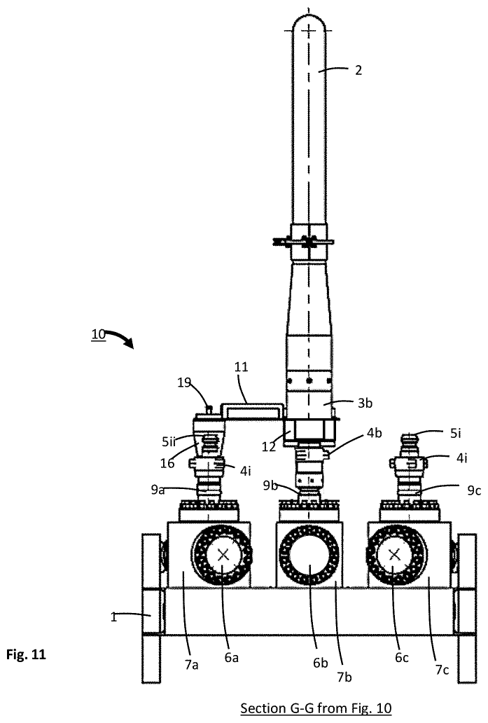

FIG. 11 which shows section G-G from FIG. 10 helps to clarify the position of the plug 5ii in the catcher 16 which has an indicator to show that a plug is present. The swing arm 11 easily allows any plug 5i or 5ii to be moved to the correct position.

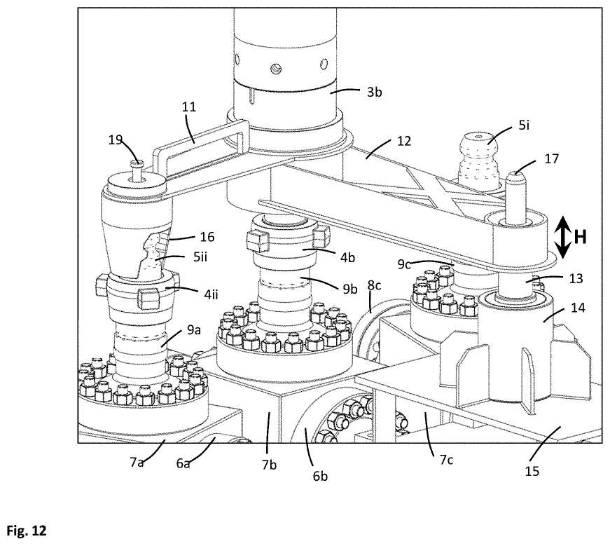

FIGS. 12 to 14 serve to illustrate one mechanism for raising and manipulation of the hose and plugs. The mechanism and operations illustrated in FIGS. 12 to 14 are representative only and practice of the disclosures herein is not limited to the exact methods illustrated.

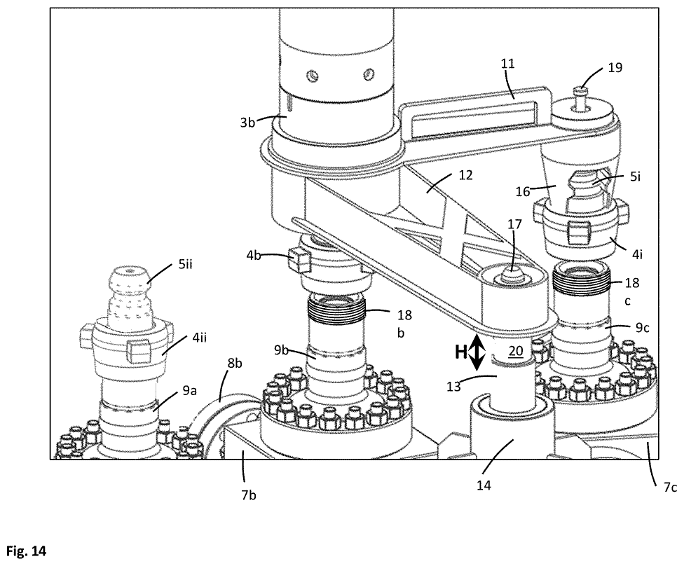

FIG. 12 shows a snapshot isometric view of the system as it has been described in FIGS. 9 to 11. The hose 2 is connected at the inlet with female hammer union (not shown) to the X-over 9d. We can see better detail of the plug catcher 16, holding plug 5ii. The plug catcher has two cut-outs, exactly opposite. One on the side shown in FIG. 12 and one on the opposite side as shown in FIG. 14. The indicator 19 is to show that the catcher is correctly engaged. The actuator arm can move up and down as shown by arrows H-H, by a piston (unseen) that sits in hydraulic cylinder 13 that rides on a pivot 17. The movement H-H can be adjusted as required for the type of connector being used.

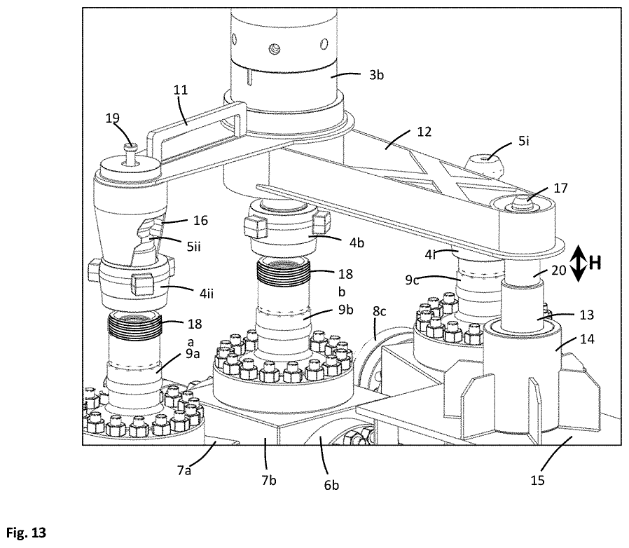

Assuming now that we want to lift the hose end 4b for moving the hose to say X-over 9a, then we would slack off hammer union 4a (not shown) on the inlet side of the hose 2. An advantage of this flexible jumper embodiment is that the inlet connection only needs to be slacked off enough for rotation, the connection does not need to be fully broken. Then we need to fully slacken off the hammer union 4b, as well as hammer union 4ii. Now referring to FIG. 13, we see that the piston 20 has emerged from the cylinder 13 and lifted the actuator arm which in turn lifts the hammer union 4b from X-over 9b, and we see the exposed threads 18b. The swing arm has also lifted the plug 5ii free exposing threads 18a of X-over 9a. In this position the actuator arm 12 can be moved anti-clockwise to bring hammer union 4b over thread 18a. This manipulation can be done manually, as there are bearings in the cylinder support 14, cylinder 13 assembly (not shown). Also, an actuation piston and cylinder as shown in FIG. 3c items 311 and 312 respectively can be used.

The swing arm 11 can be used to swing anticlockwise the plug 5ii into position over thread 18b. Then the piston 20 can be lowered, the hammer union 4b made up to thread 18a on X-over 9a and the plug hammer union 4ii made up to thread 18b. Finally, the hammer union 4a on the X-over 9d can be retightened and the “jump” is complete. This sequence can also be done for jumping to the other side from 9b to 9c.

FIG. 14 shows an alternative position snapshot in movement assuming that one would want to move the flexible jumper connection from X-over 9b to X-over 9c. Referring back to FIG. 12, here the first step would be to move the swing arm 11 all the way in a clockwise manner to engage plug 5i with the catcher 16. The catcher 16 has two open sides as already explained and is designed such that it can easily snap onto a plug 5i or 5ii when pushing in a horizontal motion. However, the plug cannot disengage from the catcher by vertical pull, so in this manner it cannot be dropped. The safety indicator 19 serves to ensure that the catcher 16 is properly engaged. Now the starting procedure is as already described: slack off hammer union 4a (not shown) on the inlet side of the hose 2. Then we need to fully slacken off the hammer union 4b, as well as hammer union 4i. Now referring to FIG. 14, we see that the piston 20 has emerged from the cylinder 13 and lifted the actuator arm which in turn lifts the hammer union 4b from X-over 9b, and we see the exposed threads 18b. The swing arm has also lifted the plug 5i free exposing threads 18c of X-over 9c. In this position the actuator arm 12 can be moved clockwise to bring hammer union 4b over thread 18c. The swing arm 11 can be used to swing anticlockwise plug 5i into position over thread 18b. Then the piston 20 can be lowered, the hammer union 4b made up to thread 18c on X-over 9c and the plug hammer union 4i made up to thread 18b. Finally, the hammer union 4a on the X-over 9d can be retightened and the “jump” is complete.

So far, the description has been made with conventional hammer unions for ease of drawings and description. Of course, the connectors can be of any type and advantageously they could be of the remote operated clamp type as disclosed in drawing FIG. 6c. FIG. 15 discloses a connector assembly 30 that is an alternative to the connector assembly 700 disclosed in FIG. 7. The connector assembly 30 consists of an upper connector part 31 that can engage into a lower connector part 32. The connector assembly 30 is shown in the engaged position with the upper connector 31 finishing in a weld-neck 46 and the lower connector part 32 having an API ring groove 33 with a slip-on flange 34 for connection (bolt holes not shown). The upper connector 31 has a flange 35 which can meet with an equivalent flange 36 on the lower connector. A clamp 37 can be pushed in with force in direction K engaging tapered surfaces 45 and 47 on upper 31 and lower 32 connectors respectively. Only one segmented clamp is shown. The segmented clamp(s) 37 can be actuated by a mechanism as shown in FIG. 6c, assembly 307, that would sit on plate 38. The upper connector 31 has a stepped pin 51 that centers the upper connector 31 as it enters the reduced bore 47 of the lower connector. A seal 39 effects the sealing, there may be one or more of these, and the connector when fully assembled lands on shoulder 52. There may be additional trash seals on shoulder 52 (not shown). The shoulder 52 is angled down so that debris does not collect. This type of connector can be sensitive to the exact internal tapers of the split clamp 37 with respect to the corresponding tapers 45 and 46 on the connectors. The innovative feature of this design is to make the lower flange 36 adjustable. It is threaded with a thread 42 to the lower connector 32. Below is a lock nut 43, riding on the lower part of the thread 42 as indicated by 44. When the connector assembly is made up, the lower nut 43 is slacked off and then the upper flange 36 can be moved increasing or decreasing gap 41, until the optimum clamping position of the segmented clamps 37 is achieved. Then the lock nut 43 can be tightened, it may have locking bolts through it to tighten on thread 42 (not shown). This innovate feature allows the quick manufacture of the clamp segments to higher tolerances as this can be accommodated by the adjustment mechanism of flange 36 just described. The other advantage of this connector is that it only needs to be partially lifted for the seal to 39 to be in the larger upper bore of the lower connector 32 which then allows easily the rotation required by the flexible jumper mechanism described in the previous Figures.

The flexible jumper manifold and connector embodiments allows efficient manipulation of the configuration either manually or with automated air or hydraulic mechanisms to affect a very cost-effective method for preventing failures experienced with current zipper manifold designs with valves by eliminating the valves completely and replacing them with a flexible jumper and sealing blank plugs.

Embodiments of the principles of the present invention realize a number of significant advantages, including increased safety, since the automated system eliminates the possibility of human error that could otherwise result in routing pressure to pumps and exposing personnel during maintenance activities. In addition, these embodiments reduce non-productive time (NPT) as there are no valves to repair.

Although the invention has been described with reference to specific embodiments, these descriptions are not meant to be construed in a limiting sense. Various modifications of the disclosed embodiments, as well as alternative embodiments of the invention, will become apparent to persons skilled in the art upon reference to the description of the invention. It should be appreciated by those skilled in the art that the conception and the specific embodiment disclosed might be readily utilized as a basis for modifying or designing other structures for carrying out the same purposes of the present invention. It should also be realized by those skilled in the art that such equivalent constructions do not depart from the spirit and scope of the invention as set forth in the appended claims.

It is therefore contemplated that the claims will cover any such modifications or embodiments that fall within the true scope of the invention.

What is claimed is:

1. A jumper manifold for use in a fracing system comprising:
a first outlet interface for coupling to a first outlet line;
a second outlet interface for coupling to a second outlet line;
an inlet interface for coupling to an inlet line carrying a slurry under pressure; and
a flexible jumper operable to:
in a first configuration, couple the inlet interface with the first outlet interface for transporting slurry from the inlet line to the first outlet line while isolating the second outlet line; and
in a second configuration, couple the inlet interface with the second outlet interface for transporting slurry from the inlet line to the second outlet line while isolating the first outlet line.

2. The jumper manifold of claim 1, wherein the inlet interface comprises:
a spool having an inlet port for coupling to the inlet line;
a block having a passage therethrough in fluid communication with the inlet port of the spool; and
a connector in fluid communication with the passage through the block for coupling to the flexible jumper.

3. The jumper manifold of claim 2, wherein the inlet port of the spool comprises one of a plurality of inlet ports.

4. The jumper manifold of claim 3, further comprising a plug disposed within at least one of the plurality of inlet ports.

5. The jumper manifold of claim 1, wherein the first outlet interface comprises a plurality of ports for coupling to a plurality of outlet lines.

6. The jumper manifold of claim 1, wherein the first outlet interface comprises:
a spool having an outlet port for coupling to the first outlet line;
a block having a passage therethrough in fluid communication with the outlet port of the spool; and
a connector in fluid communication with the passage through the block for coupling to the flexible jumper.

7. The jumper manifold of claim 6, wherein the spool comprises a plurality of outlet ports for coupling to a plurality of outlet lines.

8. The jumper manifold of claim 7, further comprising a plug disposed within at least one of the plurality of outlet ports.

9. The jumper manifold of claim 1, wherein the flexible jumper comprises a flexible hose.

10. The jumper manifold of claim 1, wherein the flexible jumper has a first end coupled to the inlet interface and a second end, the flexible jumper adapted to pivot at the first end to allow the second end to selectively couple to one of the first and second outlet interfaces.

11. The jumper manifold of claim 1, wherein the flexible jumper has a first end selectively detachable from the inlet interface and a second end selectively detachable from the first and second outlet interfaces to allow the flexible jumper to selectively couple the inlet interface to one of the first and second outlet interfaces.

12. A skid-mounted jumper manifold for use in a fracing system comprising:
a first outlet interface mounted to a skid frame for coupling to a first outlet line;
a second outlet interface mounted to the skid frame for coupling to a second outlet line;
an inlet interface mounted to the skid frame for coupling to an inlet line carrying a slurry under pressure;
an actuator arm having an inner end pivotally mounted to an arm guide extending from the skid frame, the actuator arm operable to pivot horizontally about the arm guide such that an outer end of the actuator arm can swing between a first location positioned above the first outlet interface and a second location positioned above the second outlet interface; and
a flexible jumper having a first end connectable to the inlet interface and a second end positioned by the outer end of the actuator arm and connectable to one of the first and second outlet interfaces;
wherein the flexible jumper is operable to:
in a first configuration with the outer end of the actuator arm positioning the second end of the flexible jumper above the first outlet interface, couple the inlet interface with the first outlet interface for transporting slurry from the inlet line to the first outlet line; and
in a second configuration with the outer end of the actuator arm positioning the second end of the flexible jumper above the second outlet interface, couple the inlet interface with the second outlet interface for transporting slurry from the inlet line to the second outlet line.

13. The skid-mounted jumper manifold of claim 12, further comprising a hydraulic cylinder connected to the arm guide for selectively raising and lowering the actuator arm relative to the skid frame, wherein raising and lowering the actuator arm raises and lowers the second end of the flexible jumper relative to the skid frame to facilitate coupling and uncoupling of the second end of the flexible jumper with one of the first and second outlet interfaces.

14. The skid-mounted jumper manifold of claim 13, further comprising a swing arm having an inner end pivotally mounted to the outer end of the actuator arm;
wherein the swing arm is operable to pivot horizontally about the outer end of the actuator arm above the second end of the flexible jumper; and
wherein the swing arm is configured to have an outer end spaced apart from the inner end such that when the actuator arm positions the second end of the flexible jumper aligned above one of the first and second outlet interfaces, the outer end of the swing arm can pivot into position aligned above another of the first and second outlet interfaces.

15. The skid-mounted jumper manifold of claim 14, further comprising:
a plug adapted to be received into one of the first and second outlet interfaces for isolating the respective outlet interface when received therein; and
a plug catcher attached to the outer end of the swing arm and adapted to selectively connect to the plug for moving the plug from one of the first and second outlet interfaces to another of the first and second outlet interfaces.

16. A method of switching between wells during fracing operations comprising:
coupling a first line between a first output port of a manifold and a first well;
coupling a second line between a second output port of the manifold and a second well;
coupling, with a jumper, the first output port of the manifold with an input port of the manifold;
coupling fracing fluid from the input port of the manifold to the first well through the jumper and the first line;
recoupling the jumper between the second output port of the manifold and the input port of the manifold; and
coupling fracing fluid from the input port of the manifold to the second well through the jumper and the second line.

17. The method of claim 16, wherein recoupling the jumper comprises decoupling both a first end of the jumper corresponding to the first output port of the manifold and a second end of the jumper corresponding to the input port of the manifold.

18. The method of claim 16, wherein recoupling the jumper comprises:
decoupling a first end of the jumper from the first output port of the manifold;
pivoting the jumper; and
recoupling the first end of the jumper to the second output port of the manifold.

19. The method of claim 16, further comprising:
prior to recoupling the jumper:
isolating the first well from the first line;
depressurizing the first line; and
depressurizing an input line coupled to the input port of the manifold.

20. The method of claim 19, further comprising:
prior to recoupling the jumper:
isolating the second well from the second line; and
depressurizing the second line.
